(19) United States
(12) Patent Application Publication
(10) Pub. No.: US 2014/0164564 A1
(43) Pub. Date: Jun. 12, 2014

(54) GENERAL-PURPOSE IMPORTER FOR IMPORTING MEDICAL DATA

(71) Applicants: Gregory John Hoofnagle, Fishers, IN (US); Richard Joseph Manno, Ramsey, NJ (US); Neil Dominic D'Souza, Mount Prospect, IL (US)

(72) Inventors: Gregory John Hoofnagle, Fishers, IN (US); Richard Joseph Manno, Ramsey, NJ (US); Neil Dominic D'Souza, Mount Prospect, IL (US)

(21) Appl. No.: 14/103,607

(22) Filed: Dec. 11, 2013

Related U.S. Application Data
(60) Provisional application No. 61/736,245, filed on Dec. 12, 2012.

(51) Int. Cl. H04L 29/08; G06Q 50/22

(52) U.S. Cl. CPC H04L 67/06; G06Q 50/22
USPC 709/217

(57) ABSTRACT

Techniques for importing medical device data are described herein. In one embodiment, in response to medical device data (MDD) received at a server from a MDD capturing device over a network, an MDD converter is identified that is associated with a type of the MDD data. The identified MDD converter is utilized to convert the MDD data into intermediate data in a predetermined intermediate format. The intermediate data is then transformed into target data in a target format that is compatible with a database schema of a target medical database, and the target data is stored in the target medical database for subsequent usage.

### RELATED APPLICATIONS

This application claims the benefit of U.S. Provisional Patent Application No. 61/736,245, filed Dec. 12, 2012, which is incorporated by reference herein in its entirety.

### FIELD OF THE INVENTION

Embodiments of the present invention relate generally to data processing. More particularly, embodiments of the invention relate to importing various medical data using a general-purpose importer.

### BACKGROUND

Medical devices often send the data that was collected and/or derived in the medical devices to a hospital information system (HIS), such that the data may be further reviewed and utilized for a variety of reasons including, but not limited to, patient diagnosis, integration with the patient's electronic medical record (EMR), submittal to national registries, and medical research.

Digital imaging and communications in medicine (DICOM) structured reporting (SR) attempted to provide an industry-wide standardization for the structure and transmittance of the data between equipment manufacturers (e.g., medical device manufacturers). However, this standard has largely not been adopted by equipment manufacturers outside of a few medical modalities (most notably medical ultrasound). Instead, equipment manufacturers have implemented their own proprietary schemes for storage and transmission. To compound the matter, most companies have different schemes for different product lines and allow further customer-specific configuration of these schemes. The cumulative effect of these facts is that data sent from medical devices is very diverse.

The diversity that exists amongst output schemes of medical devices causes significant issues for vendor-neutral HIS's that are dependent on this data. To solve this problem, HIS manufacturers have been forced to develop device-specific applications for each medical device. This approach leads to high development costs, slow turnaround time, low extensibility, and limited handling of customer-specific customization.

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating a system configuration for importing medical device data for storage according to one embodiment of the invention.

FIG. 2 is a block diagram illustrating an example of a general-purpose importer according to one embodiment of the invention.

FIG. 3 is a block diagram illustrating a process flow of importing medical device data according to another embodiment of the invention.

FIG. 4 is a block diagram illustrating a system for importing medical data according to another embodiment of the invention.

FIG. 5 is a flow diagram illustrating a method for importing medical device data according to one embodiment of the invention.

FIG. 6 is a block diagram illustrating an example of a data processing system which may be used with one embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

According to some embodiments, a general-purpose importer (GPI) is utilized to perform a process that is compatible with a variety of medical device's export schemes, which allows medical device data to be imported into a HIS system having a specific target format or scheme. The term of “medical device data” refers to any medical data that is captured or generated by a specific medical device, which is a specific format associated with that specific medical device. Such a process reduces, and potentially minimizes development costs, is highly extensible, and allows for complete handling of customer-specific customizations. In one embodiment, different medical device data (MDD, or simply medical data) converters are integrated within the general-purpose importer to convert a variety of different MDD formats into a common intermediate format (CIF) (e.g., a platform independent or device independent format, such as an extensible markup language (XML) format) and store the CIF data in an intermediate data file (IDF). A medical device specific mapping template is utilized to process or map the device specific information and transform the CIF data into a final target data that is compatible with or recognizable by the intended medical database or storage (e.g., compatible with a specific database schema).

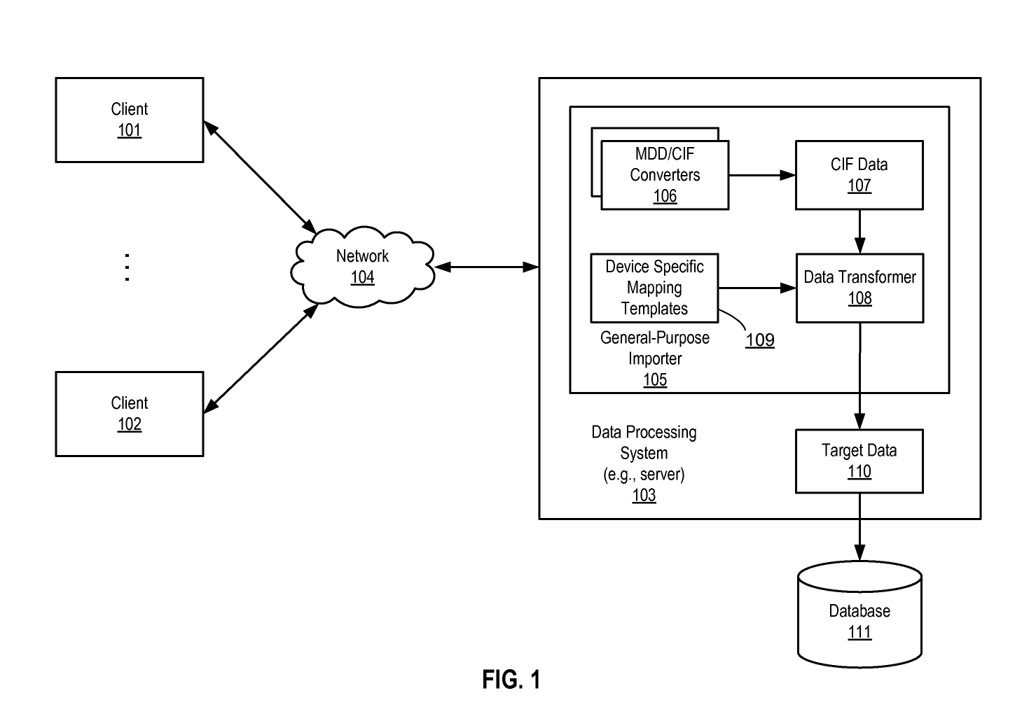

FIG. 1 is a block diagram illustrating a system configuration for importing medical device data for storage according to one embodiment of the invention. Referring to FIG. 1, system 100 includes one or more clients 101-102 representing medical data providers that provide medical data in a variety of formats. Clients 101-102 are communicatively coupled to a data processing system 103 that imports medical data for storage over network 104. Data processing system 103 may be implemented as a server or a cluster of servers over network 104 (e.g., application servers, cloud servers). Network 104 may be a local area network (LAN), a wide area network (WAN) such as the Internet, or a combination thereof, wired or wireless network.

Clients 101-102 may represent different medical devices manufactured by a variety of medical device manufacturers, where the medical devices generate different medical device data in a variety of formats, which may or may not be compatible with each other and they may or may not be compatible with a target format of a storage (e.g., HIS systems) that stores the medical device data. Clients 101-102 may be medical data capturing devices having the capability of capturing medical data (e.g., ultrasound, x-ray, computed tomography or CT, magnetic resonant imaging or MRI, etc.) and transmitting the captured medical data to data processing system 103 over network 104 for storage.

For example, clients 101-102 and server 103 may be deployed in a particular environment such as a hospital, in which clients 101-102 are configured to capture medical data and transmitted the captured medical data to server 103 over a local area network. In such situation, server 103 is configured to collect a variety of medical data. Alternatively, any of clients 101-102 may be configured as a data collector to collect medical data from other medical data capturing devices (as its clients) and aggregate the collected medical data to server 103 for conversion and storage. In such situation, server 103 may be deployed as a centralized data collection server such as a cloud server, for example, over the Internet, while clients 101-102 may represent medical data providers. Clients 101-102 and server 103 may be operated by the same or different entities or organizations.

In one embodiment, data processing system 103 includes GPI 105 to import a variety of medical data from clients 101-102 and transform into target data 110 to be stored in medical database 111. Note that GPI 105 may be implemented as logic which may include hardware, software, or a combination thereof. In one embodiment, GPI 105 includes multiple MDD-to-common-intermediate-format (MDD/CIF) converters 106, each corresponding to one of a variety of formats of medical data, which may include health level 7 (HL7), DICOM SR, which are known in the art, and any plaintext form such as a spreadsheet format (e.g., Microsoft Excel™) or an XML format. HL7 is an international community of healthcare subject matter experts and information scientists collaborating to create standards for the exchange, management and integration of electronic healthcare information. DICOM is a standard for handling, storing, printing, and transmitting information in medical imaging. It includes a file format definition and a network communications protocol. The communication protocol is an application protocol that uses transport control protocol/Internet protocol (TCP/IP) to communicate between systems. DICOM SR files can be exchanged between two entities that are capable of receiving patient data in DICOM format. The medical data can be received via a variety of ways, such as, for example, using a TCP/IP protocol, a distributed file system, or a DICOM service class provider (SCP), etc.

In one embodiment, each of the MDD/CIF converters 106 is configured to convert a specific MDD in a specific format into CIF data 107. The CIF format may be any of commonly known or agreed upon format, such as, for example, an XML format. Note that an MDD/CIF converter only reformats the MDD data into a CIF format; it preserves all medical device's specific information or parameters in the CIF data.

Based on CIF data 107, data transformer 108 is configured to transform CIF data 107 into target data 110 using a device specific mapping template 109. Device specific mapping template 109 may include information for mapping the specific device information into target data 110 centric information that is recognized by the underlying database 111. The result of using device specific mapping templates 209 may include translating and/or removing certain medical device specific information.

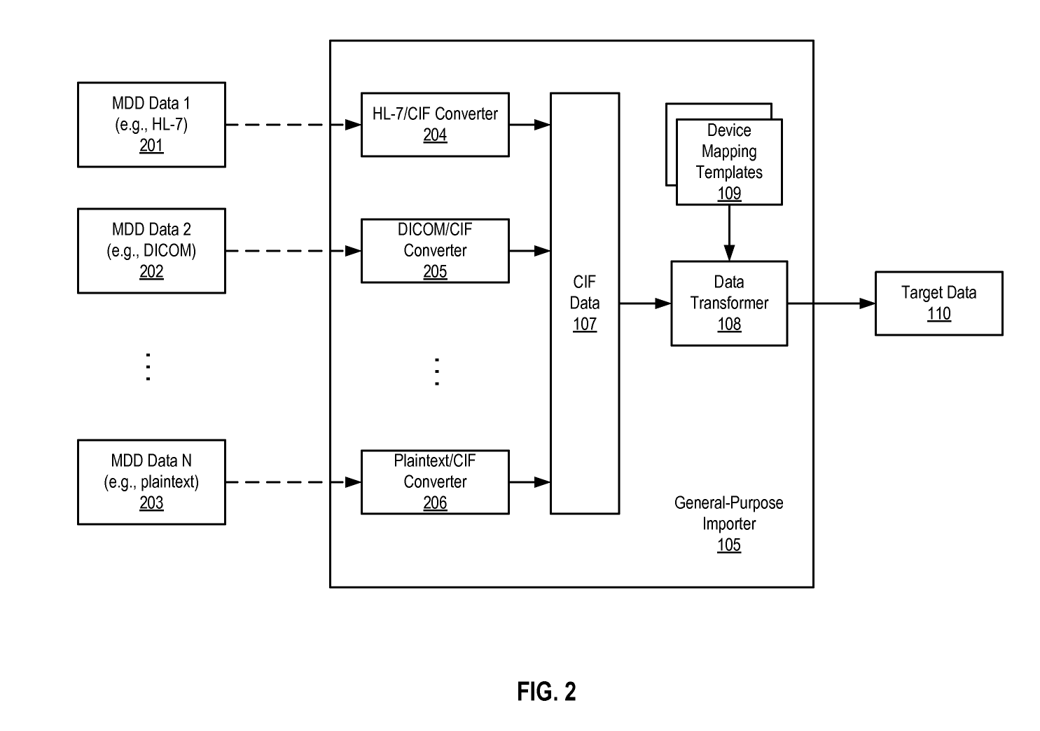

FIG. 2 is block diagram illustrating a GPI according to one embodiment of the invention. Referring to FIG. 2, GPI 105 includes multiple MDD/CIF converters 204-206, each corresponding to one of the variety of MDD formats 201-203. The MDD formats can be any of the medical device data formats available in the industry, such as HL-7, DICOM SR, or any plaintext format, such as spreadsheets (e.g., Microsoft Excel™), or an XML format. In this example, MDD/CIF converter 204 is configured to convert HL7 data 201 into CIF data 107. MDD/CIF converter 205 is configured to convert DICOM data 202 into CIF data 107. MDD/CIF converter 206 is configured to convert plaintext data 203 into CIF data 107. According to one embodiment, when MDD data is received from a remote device, an MDD/CIF converter is identified based on the type of MDD data received. The identified MDD/CIF converter is then utilized to convert that particular MDD data into CIF data. As described above, in one embodiment, an MDD/CIF converter only reformats the MDD data into a CIF format without removing or modifying any device specific information of the corresponding MDD capturing device. After all, an MDD/CIF converter may not have sufficient information or knowledge concerning the MDD capturing device. In order to process the specific device information remaining in CIF data 107, device mapping template 109 is utilized by data transformer 108 to map, modify, or remove certain device specific information in CIF data 107, generating target data 110.

According to one embodiment, data transformer 108 and mapping templates 109 are to take a manufacturer's proprietary schema and then translate that into a predetermined schema. In one embodiment, data transformer 108 is to take their description of a value and associating that value with its internal description using a corresponding mapping template. As a result, the same values, but with slightly different descriptive representations from manufacturers, are mapped into a single common description. For example, assume that there are three different medical capturing devices that are sending a patient's personal name to server 105. One system sends “Last Name”, a second system sends “Surname”; and the third system sends “Family Name.” As can be seen each manufacturer is sending the same piece of information described in a different way (e.g., different terms but referring to the same meaning). The mapping templates 109 are to map each of those to a common term and to store the patient's last name (e.g., a specific database schema used by the target medical database. This allows everything accessing database 111 to only need to know a single way of reading the content. This is just a basic example but this concept is used repeatedly for all types of data.

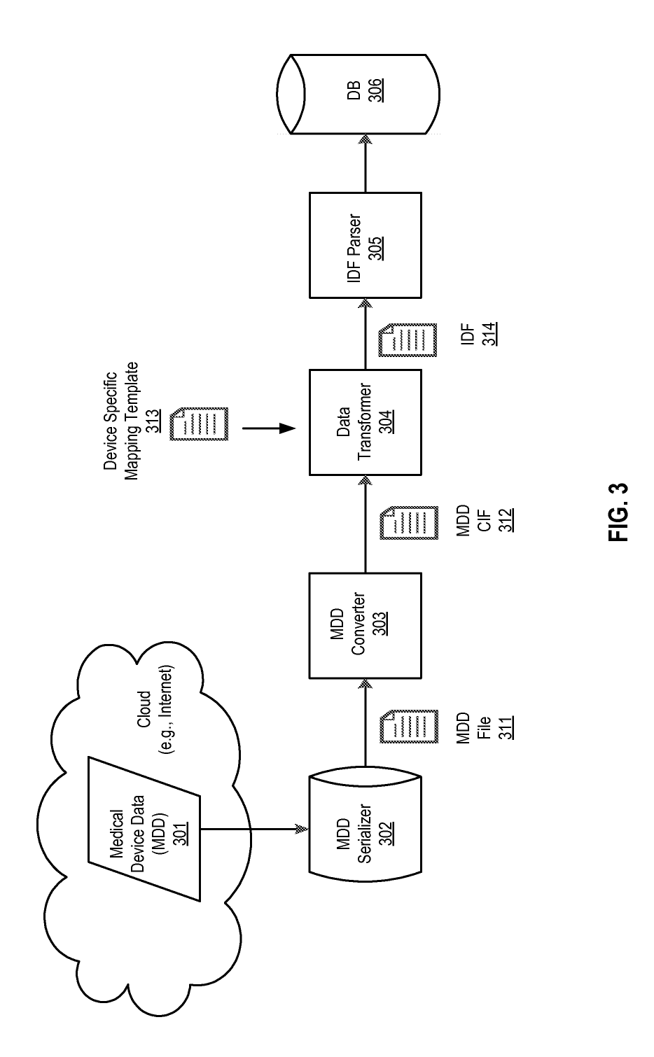

FIG. 3 is a block diagram illustrating a process flow of importing medical device data according to another embodiment of the invention. Referring to FIG. 3, initially according to one embodiment, a medical data provider or a medical device transmits MDD data 301 to a server that has implemented the GPI over a network as described above. Regardless of the device's transmittance method, MDD data 301 is serialized (e.g., stored) by an MDD serializer 302 as an MDD file 311 and stored in the file system of the server in the device's proprietary format. An example of an MDD file is shown further below, in this example, HL-7 data. MDD data 311 is converted by a selected MDD converter 303 (which is associated with the type of MDD data 301) to CIF data 312 in a CIF format, such as an XML format. An example of an MDD CIF file as shown further below, in this example, in an XML format. As described above, MDD converter 303 only reformats MDD data 301 into a CIF format, without modifying or removing the substantive content of MDD data 301. The device's proprietary data of MDD data 301 is preserved to the greatest extent possible in CIF data 312. In one embodiment, when the medical data is received, the received medical data is examined to determine the type of medical data (e.g., HL7, DICOM SR), for example, based on the specific signature or data pattern in the medical data, the communication protocols involved, and/or the types of capturing devices, etc. Based on the type of the medical data, an appropriate mapping template is identified and selected from the pool of previously configured templates.

A device-specific mapping template 313, such as an extensible stylesheet language transformation (XSLT) mapper, is applied to the MDD CIF 312 by data transformer 304. Mapping template 313 may be preconfigured to process or map the specific device information of a particular MDD capturing device. There may be multiple mapping templates that have been previously configured or defined to handle a variety of different kinds of MDD capturing devices. In one embodiment, mapping template 313 encapsulates all of the logic required to read or interpret the MDD data and to convert that MDD data into a standardized format. The transformation to a standardized data format produces an IDF file 314. An example of a device mapping template is shown further below, in this example, an XSLT mapping format, and an example of an IDF file is shown further below. Thereafter, IDF parser 305 processes or interprets IDF 314 and stores the parsed data in database 306. Since IDF's are in a device-independent format, a single IDF parser is capable of processing files from any medical device. The IDF parser 305 adds the data to the HIS database 306 which then provides access to various end-users.

Note that MDD serializer 302, MDD converter 303, and data transformer 304 may be implemented in separate processes or threads, which may operate independently (e.g., in parallel). For example, serializer 302 may be running as a first thread to receive and store MDD data 311 in a temporary storage. MDD converter 303 may be running as a second thread to independently convert MDD data 311 into CIF data 312. Data transformer 304 may be running as a third thread to transform CIF data 312 into IDF 314 using device mapping template 313. Similarly, IDF parser 305 may be executed via a fourth thread. Any of the operations performed by MDD converter 303, data transformer 304, and IDF parser may be performed offline, while other operations may be performed in real time in a distributed fashion.

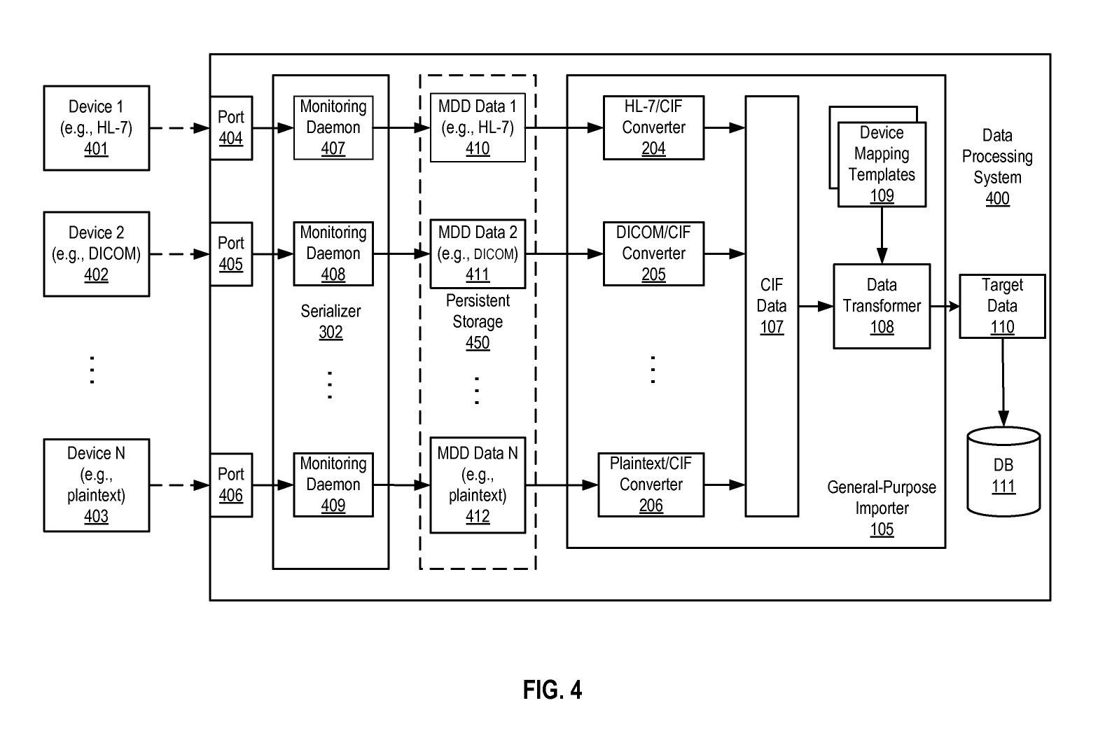

FIG. 4 is a block diagram illustrating a system for importing medical data according to another embodiment of the invention. System 400 may be implemented as part of system 103 of FIG. 1. Referring to FIG. 4, system 400 includes GPI 105 to import MDD data from a variety of devices 401-403, which may be communicatively coupled to system 400 over a network. System 400 and devices 401-403 may be deployed at a facility such as a hospital, where system 400 may be a backend server that is configured to receive and import MDD data captured by devices 401-403 over a local area network. Alternatively, system 400 may operate as a cloud server over the Internet that receives and imports MDD data from devices 401-403 as network appliance devices having capability of capturing MDD data and transmitting the MDD data to server 400 over the Internet. System 400 and devices 401-403 may be operated by the same or different organizations.

According to one embodiment, each of devices 401-403 is configured to stream the captured MDD data to server 400 to be imported and stored therein. Each of the devices 401-403 is configured to stream the MDD data to a specific TCP port of a specific IP address of server 400, in this embodiment, ports 404-406, respectively. System 400 further includes a serializer 302 to serialize MDD data received from devices 401-403. Specifically, according to one embodiment, serializer 302 includes monitoring daemons 407-409, each being configured to monitor or listen to one of ports 404-406 that expect to receive streamed MDD data from devices 401-403. In this example, a monitoring daemon may be configured to listen to network traffic associated with a specific TCP port. Monitoring daemons 407-409 may be implemented as part of a TCP/IP stack of system 400. The received MDD data is then optionally or temporarily stored in persistent storage 450 as MDD data 410-412. The MDD data buffered in storage 450 is then processed by MDD/CIF converters 204-206 subsequently.

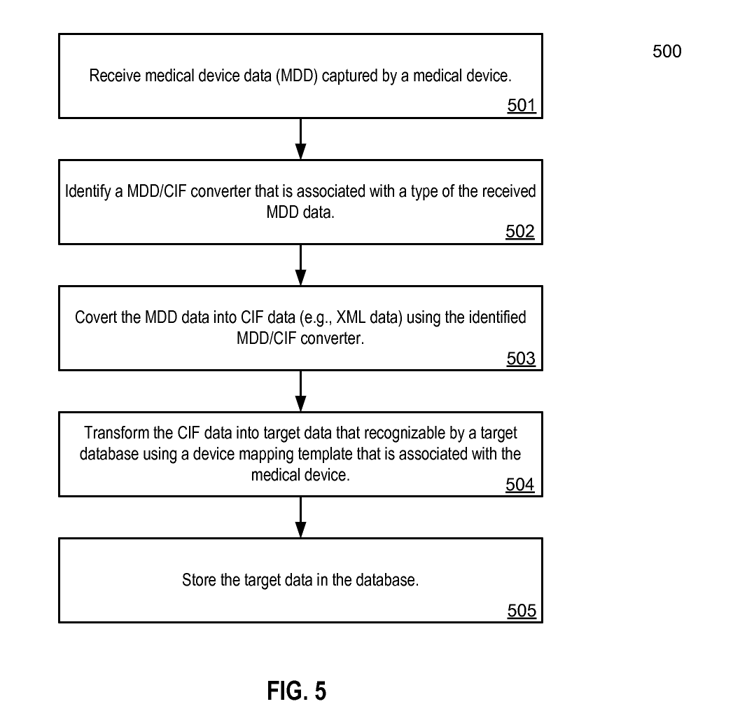

FIG. 5 is a flow diagram illustrating a method for importing medical device data according to one embodiment of the invention. Method 500 may be performed by processing logic which may include hardware, software, or a combination thereof. For example, method 500 may be performed by DPI 105 as described above. Referring to FIG. 5, at block 501, MDD data is received at the server from one or more MDD data capturing devices over a network. The MDD data can be any of HL7, DICOM, and PLAINTEXT compatible data. At block 502, a MDD/CIF converter is identified based on the type of received MDD data. At block 503, the MDD data is converted into CIF data using the identified MDD/CIF converter. At block 504, the CIF data is transformed into target data in a format compatible with the underlying database using a device specific mapping template. At block 505, the target data is then stored in the targeted database.

Historically, handling MDD required a separate software application for each medical device. The logic to read, parse, and add the data to the HIS was completely encapsulated into the application. Evolution of the MDD and customer-specific customizations required costly, and time consuming, code modifications to these applications. However, the process encapsulated by the GPI negates these issues through the implementation of a generic process for handling MDD data. The process as described throughout this application reduces the development costs and turn-around time when integrating with new medical devices by only requiring development of an MDD-to-standardized algorithm and a device-specific mapping template. The use of common MDD formats, such as HL7, further reduces development's efforts since these algorithms can be reused for multiple devices. The process provides great extensibility since all of the device-specific logic is encapsulated in the device mapping template. The device mapping templates are executed in real-time, rather than at compile-time, which enable modifications to the device's logic after development and deployment (e.g., without having to modify the executable code after its release). This effectively allows the process of evolution of an MDD (i.e. new device version) without inherently requiring a change to the GPI software itself. This same methodology also allows the process to handle customer-specific customizations of the MDD.

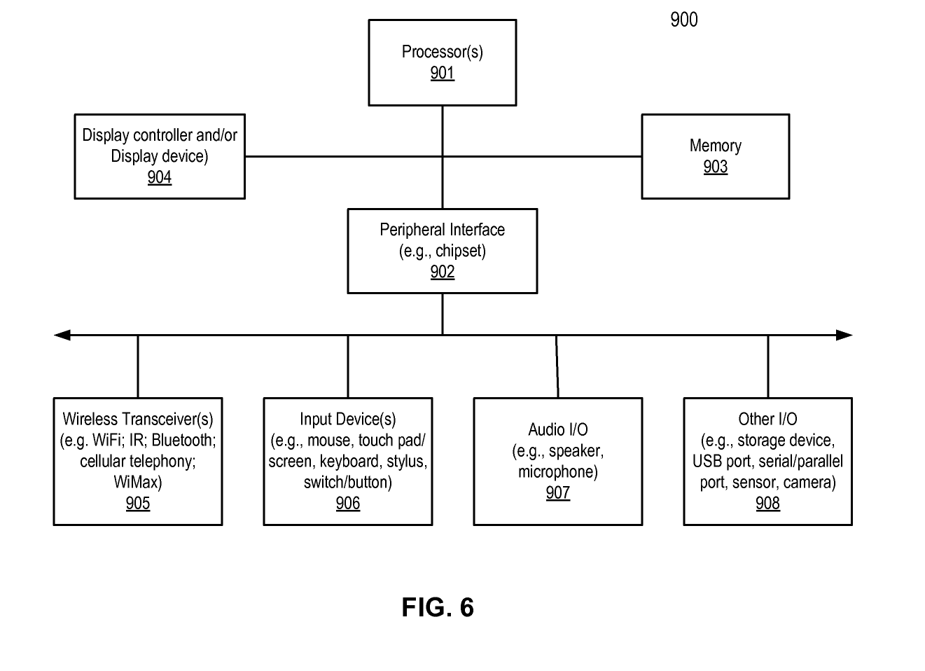

FIG. 6 is a block diagram illustrating an example of a data processing system which may be used with one embodiment of the invention. For example, system 900 may represents any of data processing systems described above performing any of the processes or methods described above, such as, for example, system 103 of FIG. 1 or system 400 of FIG. 4. System 900 may represent a server or a client such as a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof.

Referring to FIG. 6, in one embodiment, system 900 includes processor 901 and peripheral interface 902, also referred to herein as a chipset, to couple various components to processor 901 including memory 903 and devices 905-908 via a bus or an interconnect. Processor 901 may represent a single processor or multiple processors with a single processor core or multiple processor cores included therein. Processor 901 may represent one or more general-purpose processors such as a microprocessor, a central processing unit (CPU), or the like. More particularly, processor 901 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 901 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 901 is configured to execute instructions for performing the operations and steps discussed herein.

Peripheral interface 902 may include memory control hub (MCH) and input output control hub (ICH). Peripheral interface 902 may include a memory controller (not shown) that communicates with a memory 903. Peripheral interface 902 may also include a graphics interface that communicates with graphics subsystem 904, which may include a display controller and/or a display device. Peripheral interface 902 may communicate with graphics device 904 via an accelerated graphics port (AGP), a peripheral component interconnect (PCI) express bus, or other types of interconnects.

An MCH is sometimes referred to as a Northbridge and an ICH is sometimes referred to as a Southbridge. As used herein, the terms MCH, ICH, Northbridge and Southbridge are intended to be interpreted broadly to cover various chips who functions include passing interrupt signals toward a processor. In some embodiments, the MCH may be integrated with processor 901. In such a configuration, peripheral interface 902 operates as an interface chip performing some functions of the MCH and ICH. Furthermore, a graphics accelerator may be integrated within the MCH or processor 901.

Memory 903 may include one or more volatile storage (or memory) devices such as random access memory (RAM), dynamic RAM (DRAM), synchronous DRAM (SDRAM), static RAM (SRAM), or other types of storage devices. Memory 903 may store information including sequences of instructions that are executed by processor 901, or any other device. For example, executable code and/or data of a variety of operating systems, device drivers, firmware (e.g., input output basic system or BIOS), and/or applications can be loaded in memory 903 and executed by processor 901. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

Peripheral interface 902 may provide an interface to IO devices such as devices 905-908, including wireless transceiver(s) 905, input device(s) 906, audio IO device(s) 907, and other IO devices 908. Wireless transceiver 905 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. Input device(s) 906 may include a mouse, a touch pad, a touch sensitive screen (which may be integrated with display device 904), a pointer device such as a stylus, and/or a keyboard (e.g., physical keyboard or a virtual keyboard displayed as part of a touch sensitive screen). For example, input device 906 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO 907 may include a speaker and/or a microphone to facilitate voice-enabled functions, such as voice recognition, voice replication, digital recording, and/or telephony functions. Other optional devices 908 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 908 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Note that while FIG. 6 illustrates various components of a data processing system, it is not intended to represent any particular architecture or manner of interconnecting the components; as such details are not germane to embodiments of the present invention. It will also be appreciated that network computers, handheld computers, mobile phones, and other data processing systems which have fewer components or perhaps more components may also be used with embodiments of the invention.

An embodiment of MDD data is shown as follows:

OBX|18|ST|Event_Intervention_Lesion||1\hat{ }mRCA\hat{ }1\hat{ }Coronary\hat{ }\hat{ }\hat{ }\hat{ }\hat{ }\hat{ }\hat{ }\hat{ }\hat{ }\hat{ }\hat{ }\hat{ }\hat{ }
Unspecified\hat{ }\hat{ }Unspecified\hat{ }Unspecified\hat{ }Successful\hat{ }Unspecified\hat{ }2\hat{ }1
\hat{ }\hat{ }\hat{ }\hat{ }\hat{ }\hat{ }\hat{ }\hat{ }\hat{ }\hat{ }\hat{ }0\hat{ }\hat{ }0\hat{ }0\hat{ }1\hat{ }0||||||F|||20060306102926||||
OBX|19|ST|Event_Intervention_Treatment||1\hat{ }1\hat{ }1\hat{ }Balloon\hat{ }\hat{ }\hat{ }1\hat{ }\hat{ }||||||F|||
20060306102926||||
OBX|22|ST|Event_Intervention_Attempt||1\hat{ }1\hat{ }1\hat{ }1\hat{ }60\hat{ }6.00\hat{ }0.00\hat{ }0.00\hat{ }
0.00||||||F|||20060306102926||

An embodiment of an MDD CIF file is shown as follows:

```
<OBX>
  <Value Identifier=“0”>OBX</Value>
  <Value Identifier=“1”>18</Value>
  <Value Identifier=“2”>ST</Value>
  <Value Identifier=“3”>Event_Intervention_Lesion</Value>
  <Value Identifier=“5.1”>1</Value>
  <Value Identifier=“5.2”>mRCA</Value>
  <Value Identifier=“5.3”>1</Value>
  <Value Identifier=“5.4”>Coronary</Value>
  <Value Identifier=“5.17”>Unspecified</Value>
  <Value Identifier=“5.19”>Unspecified</Value>
  <Value Identifier=“5.20”>Unspecified</Value>
  <Value Identifier=“5.21”>Successful</Value>
  <Value Identifier=“5.22”>Unspecified</Value>
  <Value Identifier=“5.23”>2</Value>
  <Value Identifier=“5.24”>1</Value>
  <Value Identifier=“5.35”>0</Value>
  <Value Identifier=“5.37”>0</Value>
  <Value Identifier=“5.38”>0</Value>
  <Value Identifier=“5.39”>1</Value>
  <Value Identifier=“5.40”>0</Value>
  <Value Identifier=“11”>F</Value>
  <Value Identifier=“14”>20060306102926</Value>
</OBX>
<OBX>
  <Value Identifier=“0”>OBX</Value>
  <Value Identifier=“1”>19</Value>
  <Value Identifier=“2”>ST</Value>
  <Value Identifier=“3”>Event_Intervention_Treatment</Value>
  <Value Identifier=“5.1”>1</Value>
  <Value Identifier=“5.2”>1</Value>
  <Value Identifier=“5.3”>1</Value>
  <Value Identifier=“5.4”>Balloon</Value>
  <Value Identifier=“5.7”>1</Value>
  <Value Identifier=“11”>F</Value>
  <Value Identifier=“14”>20060306102926</Value>
</OBX>
<OBX>
  <Value Identifier=“0”>OBX</Value>
  <Value Identifier=“1”>22</Value>
  <Value Identifier=“2”>ST</Value>
  <Value Identifier=“3”>Event_Intervention_Attempt</Value>
  <Value Identifier=“5.1”>1</Value>
  <Value Identifier=“5.2”>1</Value>
  <Value Identifier=“5.3”>1</Value>
  <Value Identifier=“5.4”>1</Value>
  <Value Identifier=“5.5”>60</Value>
  <Value Identifier=“5.6”>6.00</Value>
  <Value Identifier=“5.7”>0.00</Value>
  <Value Identifier=“5.8”>0.00</Value>
  <Value Identifier=“5.9”>0.00</Value>
  <Value Identifier=“11”>F</Value>
  <Value Identifier=“14”>20060306102926</Value>
</OBX>
```

An embodiment of a device mapping template is shown as follows:

```
<!--Event_Intervention_Lesion OBX-->
      <xsl:if test=“Value[@Identifier=‘3’]=‘Event_Intervention_Lesion’”>
        <CompositeInstance Name=“Vessel Segment Properties”>
        <xsl:call-template name=“CompositeInstanceDetails”>
          <xsl:with-param name=“CompositeCode” select=“‘C24’” />
        </xsl:call-template>
        <xsl:choose>
          <xsl:when test=“Value[@Identifier=‘5.4’]=‘Graft’”>
          <CompositeInstance Name=“Graft Shunt Collateral Properties”>
            <xsl:call-template name=“CompositeInstanceDetails”>
            <xsl:with-param name=“CompositeCode” select=“‘C17’” />
        </xsl:call-template>
        <xsl:variable name=“GraftType”>
          <xsl:choose>
          <xsl:when test=“Value[@Identifier=‘5.17’]=‘SVG’”>
            <xsl:value-of select=“‘SaphenousVein’”/>
          </xsl:when>
          <xsl:otherwise>
            <!--Recognized values are:
RadialArtery,Aortobifemoral,Femoropopliteal,Femorotibial,LIMA,RIMA,ABD-->
            <xsl:value-of select=“Value[@Identifier=‘5.17’]”/>
          </xsl:otherwise>
          </xsl:choose>
        </xsl:variable>
        <xsl:call-template name=“KnownDefinitionInstance”>
          <xsl:with-param name=“DefinitionCode” select=“‘1067’” />
          <xsl:with-param name=“Value” select=“$GraftType” />
        </xsl:call-template>
        <xsl:variable name=“OriginationName” select=“Value[@Identifier=‘5.19’]” />
        <CompositeInstance Name=“Orgination Vessel”>
          <xsl:call-template name=“CompositeInstanceDetails”>
          <xsl:with-param name=“CompositeCode” select=“‘C25’” />
          </xsl:call-template>
          <xsl:call-template name=“VesselLocationDetails”>
          <xsl:with-param name=“VesselName” select=“msxsl:node-
set($GlobalLesionMaps)/Map[@name=$OriginationName]/Structure”/>
          <xsl:with-param name=“VesselTopo” select=“msxsl:node-
set($GlobalLesionMaps)/Map[@name,$OriginationName]/Topo”/>
          </xsl:call-template>
        </CompositeInstance>
        <xsl:variable name=“DestinationName” select=“Value[@Identifier=‘5.20’]” />
        <CompositeInstance Name=“Destination Vessel”>
          <xsl:call-template name=“CompositeInstanceDetails”>
          <xsl:with-param name=“CompositeCode” select=“‘C26’” />
          </xsl:call-template>
          <xsl:call-template name=“VesselLocationDetails”>
          <xsl:with-param name=“VesselName” select=“msxsl:node-
set($GlobalLesionMaps)/Map[@name=$DestinationName]/Structure”/>
          <xsl:with-param name=“VesselTopo” select=“msxsl:node-
set($GlobalLesionMaps)/Map[@name=$DestinationName]/Topo”/>
          </xsl:call-template>
        </CompositeInstance>
        </CompositeInstance>
      </xsl:when>
      <xsl:otherwise>
        <CompositeInstance Name=“Vessel Name”>
        <xsl:call-template name=“CompositeInstanceDetails”>
          <xsl:with-param name=“CompositeCode” select=“‘C18’” />
        </xsl:call-template>
        <xsl:variable name=“VesselName” select=“Value[@Identifier=‘5.2’]” />
        <xsl:call-template name=“VesselLocationDetails”>
          <xsl:with-param name=“VesselName” select=“msxsl:node-
set($GlobalLesionMaps)/Map[@name=$VesselName]/Structure”/>
          <xsl:with-param name=“VesselTopo” select=“msxsl:node-
set($GlobalLesionMaps)/Map[@name,$VesselName]/Topo”/>
        </xsl:call-template>
        </CompositeInstance>
        </xsl:otherwise>
      </xsl:choose>
      <CompositeInstance Name=“Lesion Properties”>
        <xsl:call-template name=“CompositeInstanceDetails”>
        <xsl:with-param name=“ID” select=“concat(‘Lesion’,Value[@Identifier=‘5.3’])” />
        <xsl:with-param name=“CompositeCode” select=“‘C19’” />
        </xsl:call-template>
        <xsl:call-template name=“KnownDefinitionInstance”>
        <xsl:with-param name=“DefinitionCode” select=“‘1062’” />
        <xsl:with-param name=“ValueType” select=“‘Numeric’” />
        <xsl:with-param name=“Value” select=“Value[@Identifier=‘5.5’]” />
        <xsl:with-param name=“Unit” select=“‘%’” />
        </xsl:call-template>
        <xsl:call-template name=“KnownDefinitionInstance”>
        <xsl:with-param name=“DefinitionCode” select=“‘1063’” />
        <xsl:with-param name=“ValueType” select=“‘Numeric’” />
        <xsl:with-param name=“Value” select=“Value[@Identifier=‘5.6’]” />
        <xsl:with-param name=“Unit” select=“‘%’” />
        </xsl:call-template>
        <xsl:call-template name=“KnownDefinitionInstance”>
        <xsl:with-param name=“DefinitionCode” select=“‘1064’” />
        <xsl:with-param name=“ValueType” select=“‘Numeric’” />
        <xsl:with-param name=“Value” select=“substring-
before(Value[@Identifier=‘5.7’],‘:’)” />
        <xsl:with-param name=“Unit” select=“‘unitless’” />
        </xsl:call-template>
        <xsl:call-template name=“KnownDefinitionInstance”>
        <xsl:with-param name=“DefinitionCode” select=“‘1065’” />
        <xsl:with-param name=“ValueType” select=“‘Numeric’” />
        <xsl:with-param name=“Value” select=“substring-
before(Value[@Identifier=‘5.8’],‘:’)” />
        <xsl:with-param name=“Unit” select=“‘unitless’” />
        </xsl:call-template>
        <xsl:call-template name=“KnownDefinitionInstance”>
        <xsl:with-param name=“DefinitionCode” select=“‘1054’” />
        <xsl:with-param name=“Value” select=“Value[@Identifier=‘5.12’]” />
      </xsl:call-template>
      <xsl:call-template name=“KnownDefinitionInstance”>
        <xsl:with-param name=“DefinitionCode” select=“‘1157’” />
        <xsl:with-param name=“ValueType” select=“‘Boolean’” />
        <xsl:with-param name=“Value”>
        <xsl:call-template name=“BoolToString”>
          <xsl:with-param name=“value” select=“Value[@Identifier=‘5.13’]”/>
        </xsl:call-template>
        </xsl:with-param>
      </xsl:call-template>
      <xsl:call-template name=“KnownDefinitionInstance”>
        <xsl:with-param name=“DefinitionCode” select=“‘1053’” />
        <xsl:with-param name=“ValueType” select=“‘Boolean’” />
        <xsl:with-param name=“Value”>
        <xsl:call-template name=“BoolToString”>
          <xsl:with-param name=“value” select=“Value[@Identifier=‘5.14’]”/>
        </xsl:call-template>
        </xsl:with-param>
      </xsl:call-template>
      <xsl:call-template name=“KnownDefinitionInstance”>
        <xsl:with-param name=“DefinitionCode” select=“‘1059’” />
        <xsl:with-param name=“ValueType” select=“‘Boolean’” />
        <xsl:with-param name=“Value”>
        <xsl:call-template name=“BoolToString”>
          <xsl:with-param name=“value” select=“Value[@Identifier=‘5.15’]”/>
        </xsl:call-template>
        </xsl:with-param>
      </xsl:call-template>
      <xsl:call-template name=“KnownDefinitionInstance”>
        <xsl:with-param name=“DefinitionCode” select=“‘1160’” />
        <xsl:with-param name=“ValueType” select=“‘Boolean’” />
        <xsl:with-param name=“Value”>
        <xsl:call-template name=“BoolToString”>
          <xsl:with-param name=“value” select=“Value[@Identifier=‘5.16’]”/>
        </xsl:call-template>
        </xsl:with-param>
      </xsl:call-template>
      <xsl:variable name=“GuidewireSuccess”>
        <xsl:choose>
        <xsl:when test=“Value[@Identifier=‘5.21’]=‘Successful’”/>
          <xsl:value-of select=“‘False’”/>
        </xsl:when>
        <xsl:when test=“Value[@Identifier=‘5.21’]=‘Unsuccessful’”>
          <xsl:value-of select=“‘False’”/>
        </xsl:when>
        <xsl:otherwise>
          <xsl:value-of select=“‘’”/>
        </xsl:otherwise>
        </xsl:choose>
      </xsl:variable>
      <xsl:call-template name=“KnownDefinitionInstance”>
        <xsl:with-param name=“DefinitionCode” select=“‘1058’” />
        <xsl:with-param name=“ValueType” select=“‘Boolean’” />
        <xsl:with-param name=“Value” select=“$GuidewireSuccess” />
      </xsl:call-template>
      </CompositeInstance>
    </CompositeInstance>
    </xsl:if>
    <!--Event_Intervention_Treatment-->
    <xsl:if test=“Value[@Identifier=‘3’]=‘Event_Intervention_Treatment’”>
    <CompositeInstance Name=“Lesion Treatment Properties”>
      <xsl:call-template name=“CompositeInstanceDetails”>
      <xsl:with-param name=“CompositeCode” select=“‘C20’” />
      <xsl:with-param name=“ID”
select=“concat(‘Lesion’,Value[@Identifier=‘5.2’],‘Treatment’,Value[@Identifier=‘5.3’])” />
      <xsl:with-param name=“ParentCompositeID”
select=“concat(‘Lesion’,Value[@Identifier=‘5.2’])” />
      </xsl:call-template>
      <xsl:call-template name=“KnownDefinitionInstance”>
      <xsl:with-param name=“DefinitionCode” select=“‘1069’” />
      <xsl:with-param name=“Value” select=“Value[@Identifier=‘5.4’]” />
      </xsl:call-template>
      <xsl:call-template name=“KnownDefinitionInstance”>
      <xsl:with-param name=“DefinitionCode” select=“‘1070’” />
      <xsl:with-param name=“Value” select=“Value[@Identifier=‘5.5’]” />
      </xsl:call-template>
      <xsl:call-template name=“KnownDefinitionInstance”>
      <xsl:with-param name=“DefinitionCode” select=“‘1071’” />
      <xsl:with-param name=“Value” select=“Value[@Identifier=‘5.6’]” />
      </xsl:call-template>
    </CompositeInstance>
    </xsl:if>
    <!--Event_Intervention_Attempt-->
    <xsl:if test=“Value[@Identifier=‘3’]=‘Event_Intervention_Attempt’”>
    <CompositeInstance Name=“Lesion Treatment Attempt Properties”>
      <xsl:call-template name=“CompositeInstanceDetails”>
      <xsl:with-param name=“CompositeCode” select=“‘C21’” />
        <xsl:with-param name=“ID”
select=“concat(‘Lesion’,Value[@Identifier=‘5.2’],‘Treatment’,Value[@Identifier=‘5.3’],‘Attempt’,
Value[@Identifier=‘5.4’])” />
        <xsl:with-param name=“ParentCompositeID”
select=“concat(‘Lesion’,Value[@Identifier=‘5.2’],‘Treatment’,Value[@Identifier=‘5.3’])” />
      </xsl:call-template>
      <xsl:call-template name=“KnownDefinitionInstance”>
        <xsl:with-param name=“DefinitionCode” select=“‘1073’” />
        <xsl:with-param name=“Value” select=“Value[@Identifier=‘5.5’]” />
        <xsl:with-param name=“Unit” select=“‘sec’” />
        <xsl:with-param name=“ValueType” select=“‘Numeric’” />
      </xsl:call-template>
      <xsl:variable name=“LesionNumber” select=“Value[@Identifier=‘5.2’]” />
      <xsl:variable name=“TreatmentNumber” select=“Value[@Identifier=‘5.3’]” />
      <xsl:choose>
        <xsl:when
test=“../OBX[Value=‘Event_Intervention_Treatment’][Value[@Identifier=‘5.2’]=$LesionNumber
][Value[@Identifier=‘5.3’]=$TreatmentNumber]/Value[@Identifier=‘5.4’]=‘Balloon’ or
../OBX[Value=‘Event_Intervention_Treatment’][Value[@Identifier=‘5.2’]=$LesionNumber][
Value[@Identifier=‘5.3’]=$TreatmentNumber]/Value[@Identifier=‘5.4’]=‘Cutting Balloon’ or
../OBX[Value=‘Event_Intervention_Treatment’][Value[@Identifier=‘5.2’]=$LesionNumber][
Value[@Identifier=‘5.3’]=$TreatmentNumber]/Value[@Identifier=‘5.4’]=‘Bare Metal Stent’ or
../OBX[Value=‘Event_Intervention_Treatment’][Value[@Identifier=‘5.2’]=$LesionNumber][
Value[@Identifier=‘5.3’]=$TreatmentNumber]/Value[@Identifier=‘5.4’]=‘Sirolimus-Eluting
Stent’ or
../OBX[Value=‘Event_Intervention_Treatment’][Value[@Identifier=‘5.2’]=$LesionNumber][
Value[@Identifier=‘5.3’]=$TreatmentNumber]/Value[@Identifier=‘5.4’]=‘Paclitaxel-Eluting
Stent’ or
../OBX[Value=‘Event_Intervention_Treatment’][Value[@Identifier=‘5.2’]=$LesionNumber][
Value[@Identifier=‘5.3’]=$TreatmentNumber]/Value[@Identifier=‘5.4’]=‘Heparin Coated
Stent’ or
../OBX[Value=‘Event_Intervention_Treatment’][Value[@Identifier=‘5.2’]=$LesionNumber][
Value[@Identifier=‘5.3’]=$TreatmentNumber]/Value[@Identifier=‘5.4’]=‘Covered Stent’”>
        <xsl:call-template name=“KnownDefinitionInstance”>
          <xsl:with-param name=“DefinitionCode” select=“‘1074’” />
          <xsl:with-param name=“Value” select=“Value[@Identifier=‘5.6’]” />
          <xsl:with-param name=“Unit” select=“‘atm’” />
          <xsl:with-param name=“ValueType” select=“‘Numeric’” />
        </xsl:call-template>
        </xsl:when>
        <xsl:when
test=“../OBX[Value=‘Event_Intervention_Treatment’][Value[@Identifier=‘5.2’]=$LesionNumber]
[Value[@Identifier=‘5.3’]=$TreatmentNumber]/Value[@Identifier=‘5.4’]=‘DCA’”>
        <xsl:call-template name=“KnownDefinitionInstance”>
          <xsl:with-param name=“DefinitionCode” select=“‘1074’” />
          <xsl:with-param name=“Value” select=“Value[@Identifier=‘5.6’]” />
          <xsl:with-param name=“Unit” select=“‘atm’” />
          <xsl:with-param name=“ValueType” select=“‘Numeric’” />
        </xsl:call-template>
        <xsl:call-template name=“KnownDefinitionInstance”>
          <xsl:with-param name=“DefinitionCode” select=“‘1080’” />
          <xsl:with-param name=“Value” select=“Value[@Identifier=‘5.7’]” />
          <xsl:with-param name=“ValueType” select=“‘Numeric’” />
          <xsl:with-param name=“Unit” select=“‘unitless’” />
        </xsl:call-template>
        </xsl:when>
        <xsl:when
test=“../OBX[Value=‘Event_Intervention_Treatment’][Value[@Identifier=‘5.2’]=$LesionNumber]
[Value[@Identifier=‘5.3’]=$TreatmentNumber]/Value[@Identifier=‘5.4’]=‘Rotational
Atherectomy’”>
        <xsl:call-template name=“KnownDefinitionInstance”>
          <xsl:with-param name=“DefinitionCode” select=“‘1075’” />
          <xsl:with-param name=“Value” select=“Value[@Identifier=‘5.6’]” />
          <xsl:with-param name=“Unit” select=“‘rpm’” />
          <xsl:with-param name=“ValueType” select=“‘Numeric’” />
        </xsl:call-template>
        <xsl:call-template name=“KnownDefinitionInstance”>
          <xsl:with-param name=“DefinitionCode” select=“‘1078’” />
          <xsl:with-param name=“Value” select=“Value[@Identifier=‘5.7’]” />
          <xsl:with-param name=“ValueType” select=“‘Numeric’” />
          <xsl:with-param name=“Unit” select=“‘unitless’” />
        </xsl:call-template>
        <!--TODO - Set unit correctly for bun size-->
        <xsl:call-template name=“KnownDefinitionInstance”>
          <xsl:with-param name=“DefinitionCode” select=“‘1082’” />
          <xsl:with-param name=“Value” select=“Value[@Identifier=‘5.8’]” />
          <xsl:with-param name=“ValueType” select=“‘Numeric’” />
          <xsl:with-param name=“Unit” select=“‘unitless’” />
        </xsl:call-template>
        </xsl:when>
        <xsl:when
test=“../OBX[Value=‘Event_Intervention_Treatment’][Value[@Identifier=‘5.2’]=$LesionNumber]
[Value[@Identifier=‘5.3’]=$TreatmentNumber]/Value[@Identifier=‘5.4’]=‘AngioJet’”>
        <xsl:call-template name=“KnownDefinitionInstance”>
          <xsl:with-param name=“DefinitionCode” select=“‘1076’” />
          <xsl:with-param name=“Value” select=“Value[@Identifier=‘5.6’]” />
          <xsl:with-param name=“Unit” select=“‘cm3’” />
          <xsl:with-param name=“ValueType” select=“‘Numeric’” />
        </xsl:call-template>
        <xsl:call-template name=“KnownDefinitionInstance”>
          <xsl:with-param name=“DefinitionCode” select=“‘1077’” />
          <xsl:with-param name=“Value” select=“Value[@Identifier=‘5.7’]” />
          <xsl:with-param name=“Unit” select=“‘cm3’” />
          <xsl:with-param name=“ValueType” select=“‘Numeric’” />
        </xsl:call-template>
        </xsl:when>
        <xsl:when
test=“../OBX[Value=‘Event_Intervention_Treatment’][Value[@Identifier=‘5.2’]=$LesionNumber]
[Value[@Identifier=‘5.3’]=$TreatmentNumber]/Value[@Identifier=‘5.4’]=‘TEC’”>
        <xsl:call-template name=“KnownDefinitionInstance”>
          <xsl:with-param name=“DefinitionCode” select=“‘1077’” />
          <xsl:with-param name=“Value” select=“Value[@Identifier=‘5.6’]” />
          <xsl:with-param name=“Unit” select=“‘cm3’” />
          <xsl:with-param name=“ValueType” select=“‘Numeric’” />
        </xsl:call-template>
        </xsl:when>
        <xsl:when
test=“../OBX[Value=‘Event_Intervention_Treatment’][Value[@Identifier=‘5.2’]=$LesionNumber]
[Value[@Identifier=‘5.3’]=$TreatmentNumber]/Value[@Identifier=‘5.4’]=‘Laser’”>
        <xsl:call-template name=“KnownDefinitionInstance”>
          <xsl:with-param name=“DefinitionCode” select=“‘1078’” />
          <xsl:with-param name=“Value” select=“Value[@Identifier=‘5.6’]” />
          <xsl:with-param name=“ValueType” select=“‘Numeric’” />
          <xsl:with-param name=“Unit” select=“‘unitless’” />
        </xsl:call-template>
        </xsl:when>
        <xsl:when
test=“../OBX[Value=‘Event_Intervention_Treatment’][Value[@Identifier=‘5.2’]=$LesionNumber]
[Value[@Identifier=‘5.3’]=$TreatmentNumber]/Value[@Identifier=‘5.4’]=‘Gamma
Brachytherapy’ or
../OBX[Value=‘Event_Intervention_Treatment’][Value[@Identifier=‘5.2’]=$LesionNumber][
Value[@Identifier=‘5.3’]=$TreatmentNumber]/Value[@Identifier=‘5.4’]=‘Beta
Brachytherapy’”>
        <xsl:call-template name=“KnownDefinitionInstance”>
          <xsl:with-param name=“DefinitionCode” select=“‘1079’” />
          <xsl:with-param name=“Value” select=“Value[@Identifier=‘5.6’]” />
          <xsl:with-param name=“Unit” select=“‘sec’” />
          <xsl:with-param name=“ValueType” select=“‘Numeric’” />
        </xsl:call-template>
        <!--TODO - Set dose's unit-->
        <xsl:call-template name=“KnownDefinitionInstance”>
          <xsl:with-param name=“DefinitionCode” select=“‘1081’” />
          <xsl:with-param name=“Value” select=“Value[@Identifier=‘5.7’]” />
          <xsl:with-param name=“ValueType” select=“‘Numeric’” />
          <xsl:with-param name=“Unit” select=“‘unitless’” />
        </xsl:call-template>
        </xsl:when>
    </xsl:choose>
    </CompositeInstance>
  </xsl:if>
```

An embodiment of an IDF file is shown as follows:

```
<CompositeInstance Name=“Vessel Segment Properties”>
  <CompositeCode>C24</CompositeCode>
  <DataSet>Diagnostic Cath</DataSet>
  <Phase>Post LV</Phase>
  <CompositeInstance Name=“Vessel Name”>
  <CompositeCode>C18</CompositeCode>
  <DataSet>Diagnostic Cath</DataSet>
  <Phase>Post LV</Phase>
  <KnownDefinitionInstance>
    <DefinitionCode>1044</DefinitionCode>
    <ValueType>Triplet</ValueType>
    <Value>(Mid Right Coronary Artery;BARI;2)</Value>
    <DataSet>Diagnostic Cath</DataSet>
    <Phase>Post LV</Phase>
  </KnownDefinitionInstance>
  </CompositeInstance>
  <CompositeInstance Name=“Lesion Properties”>
  <ID>Lesion1</ID>
  <CompositeCode>C19</CompositeCode>
  <DataSet>Diagnostic Cath</DataSet>
  <Phase>Post LV</Phase>
  <KnownDefinitionInstance>
    <DefinitionCode>1058</DefinitionCode>
    <ValueType>Boolean</ValueType>
    <Value>False</Value>
    <DataSet>Diagnostic Cath</DataSet>
    <Phase>Post LV</Phase>
  </KnownDefinitionInstance>
  </CompositeInstance>
  </CompositeInstance>
  <CompositeInstance Name=“Lesion Treatment Properties”>
  <ID>Lesion1Treatment1</ID>
  <CompositeCode>C20</CompositeCode>
  <ParentCompositeID>Lesion1</ParentCompositeID>
  <DataSet>Diagnostic Cath</DataSet>
  <Phase>Post LV</Phase>
  <KnownDefinitionInstance>
    <DefinitionCode>1069</DefinitionCode>
    <Value>Balloon</Value>
    <DataSet>Diagnostic Cath</DataSet>
    <Phase>Post LV</Phase>
  </KnownDefinitionInstance>
  </CompositeInstance>
<CompositeInstance Name=“Lesion Treatment Attempt Properties”>
  <ID>Lesion1Treatment1Attempt1</ID>
  <CompositeCode>C21</CompositeCode>
  <ParentCompositeID>Lesion1Treatment1</ParentCompositeID>
  <DataSet>Diagnostic Cath</DataSet>
  <Phase>Post LV</Phase>
  <KnownDefinitionInstance>
    <DefinitionCode>1073</DefinitionCode>
    <ValueType>Numeric</ValueType>
    <Value>60</Value>
    <ValueUnit>sec</ValueUnit>
    <DataSet>Diagnostic Cath</DataSet>
    <Phase>Post LV</Phase>
  </KnownDefinitionInstance>
  <KnownDefinitionInstance>
    <DefinitionCode>1074</DefinitionCode>
    <ValueType>Numeric</ValueType>
    <Value>6.00</Value>
    <ValueUnit>atm</ValueUnit>
    <DataSet>Diagnostic Cath</DataSet>
    <Phase>Post LV</Phase>
  </KnownDefinitionInstance>
  </CompositeInstance>
```

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g. circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method for importing medical data, the method comprising:
in response to medical device data (MDD) received at a server from a MDD capturing device over a network, identifying an MDD converter that is associated with a type of the MDD data;
converting using the identified MDD converter the MDD data into intermediate data in a predetermined intermediate format;
transforming the intermediate data into target data in a target format that is compatible with a database schema of a target medical database; and
storing the target data in the target medical database for subsequent usage.

2. The method of claim 1, further comprising maintaining a plurality of MDD converters, each corresponding to one of a plurality of different types of MDD data.

3. The method of claim 2, wherein the plurality of different types of MDD data comprises HL7 data, DICOM SR data, and plaintext data.

4. The method of claim 1, wherein the predetermined intermediate format comprises an extensible markup language (XML) format.

5. The method of claim 1, wherein transforming the intermediate data into target data comprises applying a mapping template to the intermediate data, and wherein the mapping template is defined specifically for mapping device specific information of the MDD capturing device.

6. The method of claim 1, wherein the server is to communicate with a plurality of MDD capturing devices and to import MDD from the MDD capturing devices over the network.

7. The method of claim 6, further comprising:
for each of the MDD capturing devices, monitoring a specific network port assigned to the MDD capturing device to receive MDD streamed from the MDD capturing device; and
serializing the received MDD in a queue to be converted by a selective MDD converter.

8. A non-transitory machine-readable medium having instructions stored therein, which when executed by a processor, cause the processor to perform operations for importing medical data, the operations comprising:
in response to medical device data (MDD) received at a server from a MDD capturing device over a network, identifying an MDD converter that is associated with a type of the MDD data;
converting using the identified MDD converter the MDD data into intermediate data in a predetermined intermediate format;
transforming the intermediate data into target data in a target format that is compatible with a database schema of a target medical database; and
storing the target data in the target medical database for subsequent usage.

9. The non-transitory machine-readable medium of claim 8, wherein the operations further comprise maintaining a plurality of MDD converters, each corresponding to one of a plurality of different types of MDD data.

10. The non-transitory machine-readable medium of claim 9, wherein the plurality of different types of MDD data comprises HL7 data, DICOM SR data, and plaintext data.

11. The non-transitory machine-readable medium of claim 8, wherein the predetermined intermediate format comprises an extensible markup language (XML) format.

12. The non-transitory machine-readable medium of claim 8, wherein transforming the intermediate data into target data comprises applying a mapping template to the intermediate data, and wherein the mapping template is defined specifically for mapping device specific information of the MDD capturing device.

13. The non-transitory machine-readable medium of claim 8, wherein the server is to communicate with a plurality of MDD capturing devices and to import MDD from the MDD capturing devices over the network.

14. The non-transitory machine-readable medium of claim 13, wherein the operations further comprise:
for each of the MDD capturing devices, monitoring a specific network port assigned to the MDD capturing device to receive MDD streamed from the MDD capturing device; and
serializing the received MDD in a queue to be converted by a selective MDD converter.

15. A data processing system, comprising:
a processor; and
a memory storing instructions, which when executed from the memory, cause the processor to perform operations, the operations including
in response to medical device data (MDD) received from a MDD capturing device over a network, identifying an MDD converter that is associated with a type of the MDD data,
converting using the identified MDD converter the MDD data into intermediate data in a predetermined intermediate format,
transforming the intermediate data into target data in a target format that is compatible with a database schema of a target medical database, and
storing the target data in the target medical database for subsequent usage.

16. The system of claim 15, wherein the operations further comprise maintaining a plurality of MDD converters, each corresponding to one of a plurality of different types of MDD data.

17. The system of claim 16, wherein the plurality of different types of MDD data comprises HL7 data, DICOM SR data, and plaintext data.

18. The system of claim 15, wherein the predetermined intermediate format comprises an extensible markup language (XML) format.

19. The system of claim 15, wherein transforming the intermediate data into target data comprises applying a mapping template to the intermediate data, and wherein the mapping template is defined specifically for mapping device specific information of the MDD capturing device.

20. The system of claim 15, wherein the server is to communicate with a plurality of MDD capturing devices and to import MDD from the MDD capturing devices over the network.

21. The system of claim 20, wherein the operations further comprise:
for each of the MDD capturing devices, monitoring a specific network port assigned to the MDD capturing device to receive MDD streamed from the MDD capturing device; and
serializing the received MDD in a queue to be converted by a selective MDD converter.
